(19) United States
(12) Patent Application Publication
(10) Pub. No.: US 2011/0318639 A1
(43) Pub. Date: Dec. 29, 2011

(54) Lithium manganese oxide-carbon nano composite and method for manufacturing the same

(75) Inventors: Hak Kwan Kim, Hanam (KR); Hyun Chul Jung, Yongin (KR); Dong Hyeok Choi, Suwon (KR); Kwang Bum Kim, Seoul (KR); Sang Bok Ma, Seoul (KR); Hye Ryun Choi, Seoul (KR)

(73) Assignees: INDUSTRY-ACADEMIC COOPERATION FOUNDATION, YONSEI UNIVERSITY, Seoul (KR); SAMSUNG ELECTRO-MECHANICS CO., LTD., Suwon (KR)

(21) Appl. No.: 12/926,844

(22) Filed: Dec. 13, 2010

(30) Foreign Application Priority Data
Jun. 24, 2010 (KR) 10-2010-0060149

(51) Int. Cl. H01M 4/505; G05D 23/00; H01M 4/88; B82Y 30/00

(52) U.S. Cl. 429/224; 252/182.1; 422/109; 977/742

(57) ABSTRACT

There is provided a method for manufacturing a lithium manganese oxide-carbon nano composite by mixing a lithium ion solution with a manganese ion solution, dispersing a carbon material in the solution in which the lithium ion is mixed with the manganese ion, and forming the lithium manganese oxide on a surface of the carbon material by maintaining the solution in which the carbon material is dispersed at a predetermined temperature. In addition, there is provided the lithium manganese oxide-carbon nano composite formed by coating the carbon material with the lithium manganese oxide at a thickness of several nm. There is provided a manufacturing apparatus capable of coating the carbon material with the lithium manganese oxide at a thickness of several nm.

### CROSS-REFERENCE TO RELATED APPLICATIONS

This application claims the priority of Korean Patent Application No. 10-2010-0060149 filed on Jun. 24, 2010, in the Korean Intellectual Property Office, the disclosure of which is incorporated herein by reference.

### BACKGROUND OF THE INVENTION

1. Field of the Invention

The present invention relates to a carbon nano composite for manufacturing a high-output energy storage device and a method for manufacturing the same, and more particularly, to a lithium manganese oxide-carbon nano composite and a method for manufacturing the same.

2. Description of the Related Art

Generally, an electrochemical energy storage device, which is a core component that is essential for use in finished products such as portable information communications devices, and other electronic devices, has recently gathered attention as a high-quality energy storage device within the field of renewable energy, such as for a future electric car, storing wind power, solar energy, or the like.

An electrochemical capacitor as a currently developed new-generation energy storage system is a high-output energy storage device that has excellent characteristics in terms of energy density as compared to a dielectric capacitor and excellent characteristics in terms of output density as compared to a rechargeable battery. Therefore, the electrochemical capacitor has been used as a power supply for driving portable electronic communications devices, an electric car, a hybrid car, or the like, that demand high energy output within a short period of time.

A representative energy storage system using an electrochemical principle may include a lithium ion battery and an electrochemical capacitor. Recently, the electrochemical capacitor has been developed to maximize the capacity of a high-output capacitor, so as to improve the output characteristics of a high-capacity lithium rechargeable battery.

The lithium rechargeable battery is a battery that can be consecutively recharged using lithium ions. The lithium rechargeable battery is excellent in terms of the amount of energy (energy density) that can be stored per unit weight or volume, but has degraded efficiency in terms of service lifespan, charging time, and amount of energy (output density) usable per unit time.

The electrochemical capacitor is classified into an electrochemical double layer capacitor (EDLC) using an electrochemical double layer phenomenon at an electrode-electrolyte interface and a pseudo capacitor having high capacitance by a reversible faraday oxidation-reduction reaction at the electrode-electrolyte interface.

An example of a metal oxide for a cathode of a lithium rechargeable battery may include LiCoO₂, LiMn₂O₄, LiCo_{1/3}Ni_{1/3}Mn_{1/3}O₂, LiFePO₄, or the like. Among others, LiCoO₂ has been mainly used. However, research into LiMn₂O₄ has been conducted in order to replace expensive Co and improve output characteristics.

An example of the electrode material of the pseudo capacitor may include a metal oxide-based conductive polymer, or the like. In particular, RuO₂, among transition metal oxides used as a pseudo capacitor electrode material, has very high specific capacitance, long operating time, high electric conductivity, and excellent high-rate capability in an aqueous electrolyte.

RuO₂ has the above-mentioned excellent characteristics but is expensive. As a result, efforts to replace RuO₂ have been actively conducted. High-capacity and inexpensive LiMn₂O₄ has been developed as a replaceable electrode material. As a method for manufacturing LiMn₂O₄, a method for mixing a lithium salt and a manganese salt into a solid-phase powder and performing a high-temperature heat treatment (at a temperature of 500° C. or more) thereupon has been most frequently used. The solid-phase powder has been manufactured into a powder state having an μm size. In order to maximize the electrochemical utility of the metal oxide, the development of lithium manganese oxide having a nano size has been undertaken.

### SUMMARY OF THE INVENTION

An aspect of the present invention provides a lithium manganese oxide-carbon nano composite for manufacturing an electrode having high energy density and high output characteristics and a method for manufacturing the same.

According to an aspect of the present invention, there is provided a method for manufacturing a lithium manganese oxide-carbon nano composite by mixing a lithium ion solution with a manganese ion solution, dispersing a carbon material in the solution in which the lithium ion is mixed with the manganese ion, and forming the lithium manganese oxide on a surface of the dispersed carbon material by maintaining the solution in which the carbon material is dispersed at a predetermined temperature.

The carbon material may be any one of carbon black, a carbon nano tube (CNT), a carbon nano fiber (CNF), a vapor grown carbon fiber (VGCF), graphite, and grephene.

The lithium ion may be a mono-valence lithium ion and the lithium ion solution may be any one of LiOH, LiNO₃ and LiCl.

The manganese ion may be a 7-valence manganese ion and the manganese ion solution may be any one of KMnO₄ and NaMnO₄.

The method for manufacturing a lithium manganese oxide-carbon nano composite may further include controlling at least one of the amount of lithium, the amount of manganese, the amount of carbon material, a reaction time, and a synthesis temperature in order to control any one of a coated thickness and a coated amount of the lithium manganese oxide and a ratio of lithium to manganese of the lithium manganese oxide.

The method for manufacturing a lithium manganese oxide-carbon nano composite further may include controlling at least one of the temperature and pressure during the coating in order to control the coating of the lithium manganese oxide.

According to another aspect of the present invention, there is provided a lithium manganese oxide-carbon nano composite including: a carbon material and a nano-sized lithium manganese oxide formed on the surface of the carbon material.

The lithium manganese oxide formed in the carbon material may have a size of 10 nm or less.

The lithium manganese oxide formed in the carbon material has a lithium manganese oxide-spinel structure.

The carbon material may be any one of carbon black, a carbon nano tube (CNT), a carbon nano fiber (CNF), a vapor grown carbon fiber (VGCF), graphite, and grephene.

The lithium manganese oxide may be LiMn₂O₄.

According to another aspect of the present invention, there is provided an apparatus for manufacturing a lithium manganese oxide-carbon nano composite, including: an airtight chamber receiving a lithium ion solution and a manganese ion solution and synthesizing a lithium manganese oxide with a carbon nano composite; a heat supply unit supplying heat to the airtight chamber; a temperature-pressure measuring unit measuring at least one of temperature and pressure in the airtight chamber in order to control heat supplied to the heat supply unit; and a temperature-pressure control unit controlling at least one of temperature and pressure according to the measured temperature and pressure.

The heat supply unit may be a microwave scanning apparatus.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a flowchart showing a method for manufacturing a lithium manganese oxide-carbon nano composite according to the present invention;

FIG. 2 is a graph showing absorbance according to a waveform of a synthesis solution before and after the manganese ion solution according to the present invention is heat-treated in the water;

FIG. 3 is a graph showing a cyclic voltammogram after and before the lithium manganese oxide-carbon nano composite according to the present invention is heat-treated in the water;

FIG. 4 is a graph showing a constant current charge and discharge profile before and after the lithium manganese oxide-carbon nano composite according to the present invention is heat-treated in the water;

FIG. 5 is a graph showing a discharge curve for each C-rate of the lithium manganese oxide-carbon nano composite according to the present invention;

FIG. 6 is a graph showing a C-rate dependency of specific capacitance of the lithium manganese oxide-carbon nano composite according to the present invention; and

FIG. 7 is a flowchart showing life characteristics of a lithium manganese oxide-carbon nano composite according to the present invention.

### DETAILED DESCRIPTION OF THE PREFERRED EMBODIMENT

Hereinafter, exemplary embodiments will be described in detail with reference to the accompanying drawings so that they can be easily practiced by those skilled in the art to which the present invention pertains. However, in describing the exemplary embodiments of the present invention, detailed descriptions of well-known functions or constructions are omitted so as not to obscure the description of the present invention with unnecessary detail.

In addition, like reference numerals denote parts performing similar functions and actions throughout the drawings.

It will be understood that when an element is referred to as being “connected with” another element, it can be directly connected with the other element or may be indirectly connected with the other element with element(s) interposed therebetween. Unless explicitly described to the contrary, the word “comprise” and variations such as “comprises” or “comprising,” will be understood to imply the inclusion of stated elements but not the exclusion of any other elements.

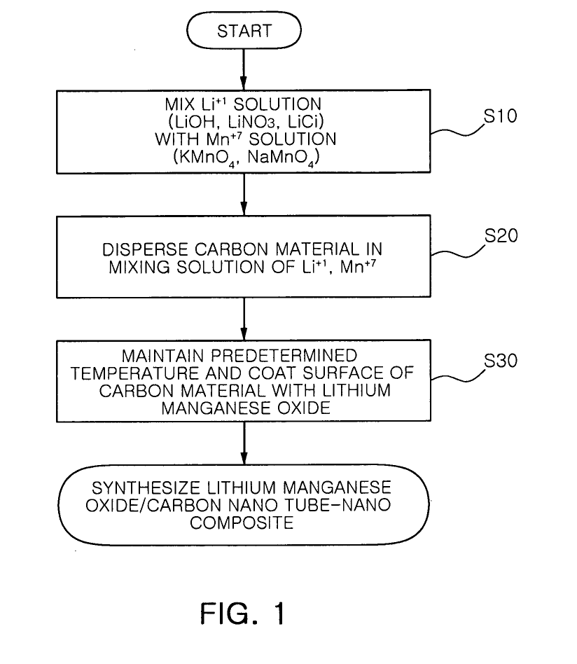

Hereinafter, a carbon nano composite coated with a lithium manganese oxide and a method for manufacturing the same according to the present invention will be described with reference to FIG. 1.

FIG. 1 is a flowchart explaining a method for manufacturing a lithium manganese oxide-carbon nano composite according to the present invention.

A method for manufacturing a lithium manganese oxide-carbon nano composite according to the present invention includes mixing a lithium ion solution with a manganese ion solution (S10), dispersing a carbon material in the solution in which the lithium ion and the manganese ion are mixed (S20), and coating the surface of the carbon material with the lithium manganese oxide by maintaining the solution in which the carbon material is dispersed at a predetermined temperature (S30).

Each step will now be described in more detail.

In order to manufacture the lithium manganese oxide-carbon nano composite, the lithium ion solution and the manganese ion solution are mixed with each other (S10).

A lithium mono-valence solution is used as a lithium ion solution. The lithium ion is not limited thereto, but LiOH, LiNO₃, LiCl, or the like may be used. In addition, a manganese 7-valence solution is used as the manganese ion solution. The manganese ion solution is not limited thereto, but KMnO₄ or NaMnO₄, or the like, may be used.

The manganese 7-valence ion is mixed with the lithium mono-valence ion by mixing the lithium ion with the manganese ion.

The carbon material is dispersed in a solution in which the lithium ion and the manganese ion are mixed (S20). An example of the carbon material may include carbon black, a carbon nano tube (CNT), a carbon nano fiber (CNF), a vapor grown carbon fiber (VGCF), graphite, grephene, or the like, but is not limited thereto.

According to the present invention, the carbon material may be dispersed without using a separate oxidizer or reducer or supplying electrical energy by dispersing the carbon material in the solution in which the lithium mono-valence ion and the manganese 7-valence ion are mixed, in order to disperse the carbon material (hereinafter, ‘carbon nano tube’ will be used herein to describe the carbon material).

After dispersing the carbon nano-tube, the lithium manganese oxide-carbon nano composite is manufactured through a step (S30) of coating the surface of the carbon material with the lithium manganese oxide by maintaining the solution, in which the carbon nano tube is dispersed, at a predetermined temperature.

The process of forming LiMn₂O₄ by adding the carbon nano composite to the mixing solution of the lithium ion solution and the manganese ion solution may be described by the following reaction formula.

MnO⁴⁻+4H⁺+3e⁻→MnO₂+2H₂O

MnO₂+2H₂O→Mn⁴⁺+4OH⁻

8Mn⁴⁺+4Li⁺+36OH⁻→4LiMn₂O₄+18H₂O+O₂

The reaction is made by supplying heat. The carbon nano composite serves as a reducing modifier and a substrate.

A permanganate ion is reduced into MnO₂ on the carbon nano composite by supplying heat and the reduced MnO₂ exists in a Mn +4-valence ion state through a hydrolysis reaction. The Mn +4-valence ion is reduced into LiMn₂O₄ by LiOH and is distributed to be educed on the carbon nano composite.

The reaction, which is an endothermic reaction, requires the supply of heat. The present invention may supply heat through a microwave hydrothermal process.

The exemplary embodiment of the present invention provides an apparatus for manufacturing the lithium manganese oxide-carbon nano composite, including an airtight chamber, a heat supply unit, a temperature-pressure measuring unit, and a temperature-pressure control unit.

In order to coat the carbon nano tube with the lithium manganese oxide, the solution in which the manganese 7-valence ion and the lithium mono-valence ion are mixed is put into the airtight chamber. The carbon material put into the airtight chamber is dipped into the mixing solution. The carbon material may be dispersed without supplying the separate oxidizer or reducer or the separate electrical energy (S20).

The apparatus for manufacturing the lithium manganese oxide-carbon nano composite includes the heat supply unit. The heat supply unit may use a microwave scanning apparatus that heats the solution in the airtight chamber with microwave scanning apparatus. The temperature of the mixing solution in the airtight chamber rises due to the microwave scanning apparatus. The temperature in the chamber can rapidly and uniformly rise due to the microwave scanning apparatus.

Thereafter, the temperature is maintained constantly in order to induce the coating of the carbon material with the lithium manganese oxide. In order to maintain the predetermined temperature, the apparatus for manufacturing the lithium manganese oxide-carbon nano composite may include the temperature-pressure measuring unit that can measure the temperature and/or pressure in the chamber. In order to maintain the preset temperature according to the measured temperature and/or pressure data values, the apparatus for manufacturing the lithium manganese oxide-carbon nano composite may include the temperature-pressure control unit that controls the temperature in the chamber.

The temperature in the chamber may be constantly maintained by using the temperature-pressure measuring unit and the temperature-pressure control unit and may induce the coating of the carbon material with the lithium manganese oxide (S30).

According to the exemplary embodiment of the present invention, at least one of the amount of lithium, the amount of manganese, the amount of carbon material, the reaction time, and the synthesis temperature can be controlled in order to control the coating amount and the coating thickness of the lithium manganese oxide and the ratio of lithium to manganese in the lithium manganese oxide.

The amount of lithium ion solution may be controlled in order to control the amount of lithium, and the amount of lithium ion solution may be controlled in order to control the amount of manganese. The ratio of lithium to manganese in the lithium manganese oxide can be controlled in the above-mentioned manner.

Further, in order to control the coating amount and the coating thickness of the lithium manganese oxide, the coating rate can be controlled by controlling at least one of the amount of lithium ion, the amount of manganese, and the amount of carbon material within the mixing solution and the coating amount and the coating thickness of the lithium manganese oxide can be controlled by controlling the reaction time or the synthesis temperature.

The lithium manganese oxide-carbon nano composite according to the present invention may perform the coating by the simple process without using the oxidizer or reducer or supplying the separate electrical energy. In addition, most of the carbon material including the lithium manganese oxide formed at the nm thickness may contribute to the specific capacitance even in the high-output conditions, such that the electrochemical utility of the lithium manganese oxide is increased and the electric conductivity is improved.

The lithium manganese oxide is coated on the carbon nano tube. In the case of the lithium manganese oxide-carbon nano composite manufactured by the manufacturing method according to the present invention, it can be confirmed that the nano particles are consecutively uniformly coated on the carbon nano tube. Therefore, the agglomeration phenomenon between the carbon nano tube particles may be prevented. The agglomeration of the nano particles caused by being entangled with other particles and wound thereto and the agglomeration of the nano particles caused by surface tension such as van der Waals forces between molecules at an nm level can be prevented. Therefore, it may help in forming 3-dimensional network architecture capable of improving mechanical strength or conductive characteristics and a 3-dimensional porous structure.

In addition, the basic structure of the lithium manganese oxide has a lithium manganese oxide-spinel (LiMn₂O₄-Spinel) structure. The lithium ion has a lattice structure capable of being three-dimensionally diffused by having the spinel structure, such that the carbon nano composite according to the present invention is advantageous in facilitating the separation/insertion of the lithium ion as compared to other lithium manganese oxides, thereby achieving the high-output characteristics.

The electrode material has a 3-dimensional porous structure due to the spinel structure of the lithium manganese oxide by forming the lithium manganese oxide-carbon nano composite and the diffusion rate of the lithium ion is increased, thereby making it possible to maximize the electrochemical utility of the electrode material. Further, most of the lithium manganese oxide-carbon nano composite manufactured according to the present invention can contribute to the specific capacitance even in the high-output conditions and improve the electric conductivity of the carbon nano composite, by coating the lithium manganese oxide at a thickness of several nm by the chemical method. Therefore, the lithium manganese oxide-carbon nano composite may be used as the high-capacity, high-output electrode material.

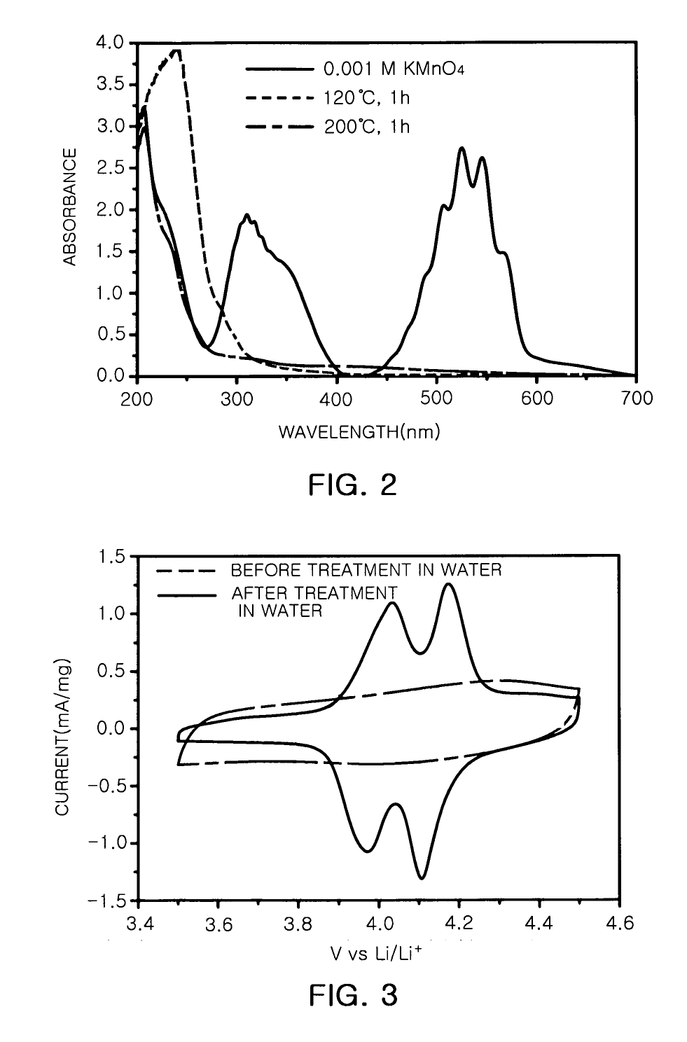

FIG. 2 is a graph showing absorbance according to a waveform of a synthesis solution before and after the manganese ion solution according to the present invention is heat-treated in the water.

Referring to FIG. 2, FIG. 2 shows the amount of manganese ion existing in the mixing solution before/after the mixing solution of the lithium ion solution and the manganese ion solution is heat-treated. The exemplary embodiment of the present invention use potassium permanganate (KMnO₄) as the manganese ion solution. Since the manganese ion is included in the mixing solution before the manganese ion solution and the lithium ion solution are heat-treated, an absorbed peak corresponding to the waveform of the manganese ion is shown.

However, it can be confirmed that the peak is not shown at the absorption wavelength of manganese ion after the manganese ion is heat-treated at a temperature of between 120° C. and 200° C. It can be confirmed that the manganese ion is reduced to LiMn₂O₄ nano particles on the carbon nano composite by the heat treatment.

The related art requires a great deal of reaction time and energy to synthesize the LiMn₂O₄. However, the microwave is applied to the manganese ion solution and the lithium ion solution to heat, thereby making it possible to very rapidly and simply synthesize the LiMn₂O₄ nano particles.

FIG. 3 is a graph showing a cyclic voltammogram before and after the lithium manganese oxide-carbon nano composite according to the present invention is heat-treated in the water.

The oxide having the spinel structure has a crystal structure of an isometric system and has excellent magnetism or electrical conductivity.

If the LiMn₂O₄ nano particles have the spinel structure, the current peak is shown at the cyclic voltammogram. It can be appreciated from FIG. 3 that two current peaks are shown, since the current peak showing the spinel structure is not observed at the carbon nano composite before the heat treatment in the water but the spinel structure of the LiMn₂O₄ nano particles are formed on the carbon nano composite after the heat treatment in the water.

Further, it can be appreciated that Li and Mn are accurately formed at a tetrahedral place and an octahedral place on the spinel structure without position confusion through a first current peak in the vicinity of 4V and a second current peak in the vicinity of 4.2V among two peaks at the cyclic voltammogram of the lithium manganese oxide-carbon nano composite after the heat-treatment in the water.

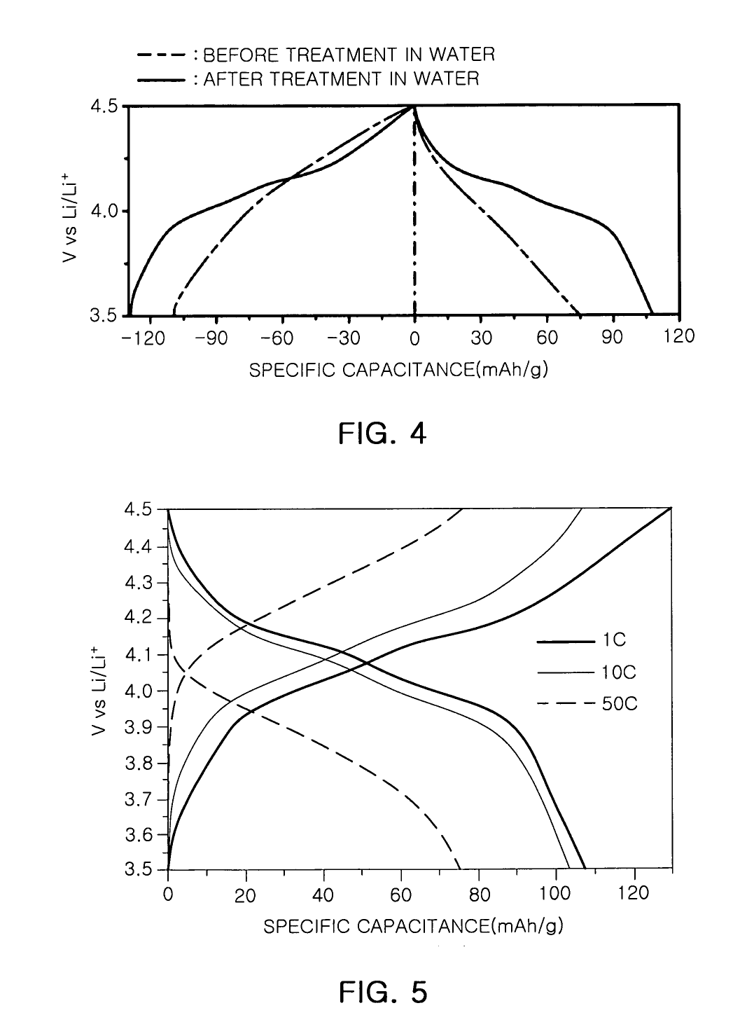

FIG. 4 is a graph showing a constant current charge and discharge profile before and after the lithium manganese oxide-carbon nano composite according to the present invention is heat-treated in the water.

When the particles have the spinel structure, a potential plateau is found in the constant current charge and discharge profile. This makes it easy to separate/insert the lithium ions by allowing the carbon composite to have the spinel structure to improve the output characteristics, such that the potential plateau is found in the constant current charge and discharge profile.

Referring to FIG. 4, in the mixing solution including the carbon material that is not subjected to the heat treatment in the water, the potential plateau is not found in the constant current charge and discharge profile; however, the potential plateau is found within the constant current charge and discharge profile, since the lithium manganese oxide-carbon nano composite is formed after the heat treatment in the water. Therefore, it can be appreciated that the LiMn₂O₄ nano particles have the spinel structure after the heat treatment in the water.

As described above, when the LiMn₂O₄ nano particles have the spinel structure, they have the lattice structure capable of three-dimensionally diffusing the lithium ion, such that they can easily separate and insert the lithium ions as compared to other lithium manganese oxides, thereby having high-output characteristics.

FIG. 5 is a graph showing a discharge curve for each C-rate of the lithium manganese oxide-carbon nano composite according to the present invention.

The current values of the charging or discharging are represented by 1C, 2C, or the like. For example, if it is assumed that there is a rechargeable battery having a capacity of 1000 mAh, the 1C charging (or discharging, in this case, the charging and discharging ends within 1 hour) is conducted when the rechargeable battery is charged (or discharged) with a current of 1000 mAh. When the rechargeable battery is charged (discharged) with a current value of 2000 mAh, the 2C charging (or discharging, in this case, the charging and discharging ends within 30 minutes). As described above, the case in which the battery capacity is completely charged or discharged within the predetermined time will now be described based on a concept referred to as a C-rate. That is, the battery capacity is defined by the current capacity rate per hour.

Referring to FIG. 5, it can be appreciated that the discharge characteristics per the C-rate of the lithium manganese oxide-carbon nano composite is finally synthesized by the heat treatment in the water. It can be appreciated that the voltage dropping width is gradually increased with the increase of the C-rate. However, since the voltage drop is small even in the high C-rate value, it can be appreciated that the electrode including the lithium manganese oxide-carbon nano composite has a very low ESR value.

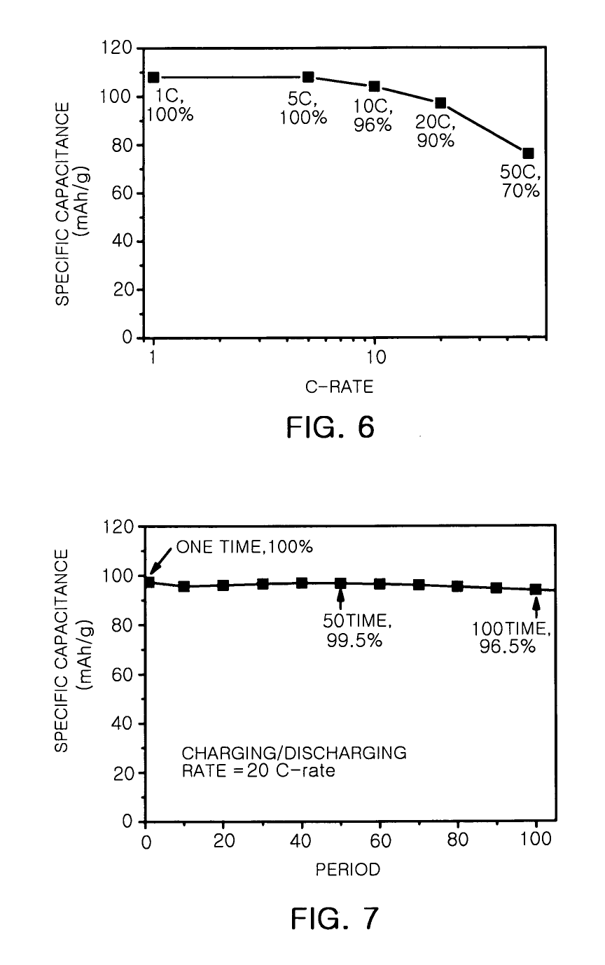

FIG. 6 is a graph showing the C-rate dependency of the specific capacitance of the lithium manganese oxide-carbon nano composite according to the present invention.

FIG. 6 shows that the specific capacitances at 10, 20, and 50C-rates are compared under the assumption that the specific capacitance demonstrated at the 1C rate is 100%.

In the lithium manganese oxide-carbon nano composite, it can be appreciated that the specific capacitance is reduced with the increase of the C-rate value and the specific capacitance of 100% is maintained up to the 5C rate. Further, it can be appreciated that the specific capacitance of 90% is maintained even at a very fast discharge rate of the 20C rate.

It can be appreciated from FIGS. 9 and 10 that the lithium manganese oxide-carbon nano composite has the very excellent high-rate discharge characteristics. The reason is that the diffusion length of the Li ion is reduced with the nanotization of the LiMn₂O₄ and the LiMn₂O₄ is uniformly coated on the carbon nano composite. Further, since the effective interfacial area between the electrolyte and the LiMn₂O₄ is increased and the accessibility of the Li ion is increased due to the porous structure between the carbon nano composites, it can be appreciated that the discharge characteristics of the electrode are improved when the lithium manganese oxide-carbon nano composite is used as the electrode.

FIG. 7 is a flowchart showing lifespan characteristics of the lithium manganese oxide-carbon nano composite according to the present invention.

Referring to FIG. 7, the life characteristics of the energy storage device when the lithium manganese oxide-carbon nano composite is used as the electrode material can be appreciated. It can be appreciated that the specific capacitance value is slightly reduced even when the charging and discharging is continued at a very fast rate of the 20C rate. It can be appreciated that the specific capacitance value of 99.5% of the initial capacity is maintained even when the charging and discharging are made 50 times and the specific capacitance value of 96.5% is maintained even when the charging and discharging are made 100 times.

Therefore, the lithium manganese oxide-carbon nano composite according to the present invention can manufacture the high-output energy storage device having the excellent high rate discharge characteristics and the excellent lifespan characteristics.

### Example

In order to synthesize the lithium manganese oxide-carbon nano composite in which the LiMn₂O₄ nano particles were dispersed, the microwave hydrothermal process was used.

In order to synthesize the lithium manganese oxide-carbon nano composite, 0.1M of a KMnO₄ aqueous solution and 1M of a LiOH aqueous solution were first mixed at the same volume and were agitated for 24 hours at normal temperature (S10).

After the mixing solution was put into the microwave hydrothermal reacting container and the carbon nano composite was added thereto (S20), the process of coating the carbon nano composite with the lithium manganese oxide was performed for 1 hour at 120° C., until the reaction was completely finished (S30). The prepared reaction products were withdrawn by centrifugal separation and then washed with distilled water several times in order to completely remove the ions remaining in the solution, and were dried for 24 hours in an oven of 100° C.

In order to control the composition of Li and Mn in the synthesized powder, after the carbon nano composite coated with the lithium manganese oxide was put in the microwave water heat treatment reaction container and the distilled water was put therein, the water heat treatment was performed for 1 hour at 200° C.

In order to completely remove the adsorption water, the synthesized powders were dried for 24 hours at 120° C. in a vacuum state.

Slurry in which the lithium manganese oxide-carbon nano composite, a conductive material, and a binder were mixed at a ratio of 67:28:5 was prepared in order to use the lithium manganese oxide-carbon nano composite as the electrode material.

In this case, acetylene black was used as the conductive material and PVDF dissolved with N-Methyl-2-Pyrrolidone (NMP) was used as the binder. After the conductive material was added to the lithium manganese oxide-carbon nano composite powder and they were uniformly mixed by a ball mill, the binder and the NMP were added thereto and they were uniformly mixed again by the ball mill.

The uniform slurry prepared by the method was applied to a titanium foil current collector to manufacture the electrode, which was then dried for 12 hours in an oven of 100° C.

As set forth above, the present invention provides the method for manufacturing a lithium manganese oxide-carbon nano composite by mixing a lithium ion solution and a manganese ion solution, dispersing a carbon material in the mixing solution of the lithium ions and the manganese ions, maintaining the solution, in which the carbon material is dispersed, at a predetermined temperature, and coating the surface of the carbon material with the lithium manganese oxide.

In addition, the present invention provides the lithium manganese oxide-carbon nano composite in which the carbon material is coated with the lithium manganese oxide at a thickness of several nm.

Further, the present invention provides the manufacturing apparatus capable of coating the carbon material with the lithium manganese oxide at a thickness of several nm.

While the present invention has been shown and described in connection with the exemplary embodiments, it will be apparent to those skilled in the art that modifications and variations can be made without departing from the spirit and scope of the invention as defined by the appended claims.

What is claimed is:

1. A method for manufacturing a lithium manganese oxide-carbon nano composite, comprising:
mixing a lithium ion solution with a manganese ion solution;
dispersing a carbon material in the solution in which the lithium ion is mixed with the manganese ion; and
synthesizing lithium manganese oxide on a surface of the dispersed carbon material.

2. The method for manufacturing a lithium manganese oxide-carbon nano composite of claim 1, wherein the synthesizing of the lithium manganese oxide supplies heat in order to maintain a predetermined temperature.

3. The method for manufacturing a lithium manganese oxide-carbon nano composite of claim 1, further comprising controlling at least one of the amount of lithium, the amount of manganese, the amount of carbon material, a reaction time, and a reaction temperature in order to control any one of the thickness of the lithium manganese oxide, the synthesis amount of the lithium manganese oxide and the ratio of lithium to manganese of the lithium manganese oxide.

4. The method for manufacturing a lithium manganese oxide-carbon nano composite of claim 1, further comprising controlling anyone of the temperature and pressure during the synthesis in order to control the synthesis of the lithium manganese oxide.

5. The method for manufacturing a lithium manganese oxide-carbon nano composite of claim 1, wherein the carbon material is any one of carbon black, a carbon nano tube (CNT), a carbon nano fiber (CNF), a vapor grown carbon fiber (VGCF), graphite, and grephene.

6. The method for manufacturing a lithium manganese oxide-carbon nano composite of claim 1, wherein the lithium ion is a mono-valence lithium ion.

7. The method for manufacturing a lithium manganese oxide-carbon nano composite of claim 1, wherein the lithium ion solution is any one of LiOH, LiNO₃ and LiCl.

8. The method for manufacturing a lithium manganese oxide-carbon nano composite of claim 1, wherein the manganese ion is a 7-valence manganese ion.

9. The method for manufacturing a lithium manganese oxide-carbon nano composite of claim 1, wherein the manganese ion solution is any one of KMnO₄ and NaMnO₄.

10. A lithium manganese oxide-carbon nano composite for manufacturing an electrode for a high-output energy storage device, comprising:
a carbon material: and
a nano-sized lithium manganese oxide formed on the surface of the carbon material.

11. The lithium manganese oxide-carbon nano composite for manufacturing an electrode for a high-output energy storage device of claim 10, wherein the lithium manganese oxide formed in the carbon material has a size of 10 nm or less.

12. The lithium manganese oxide-carbon nano composite for manufacturing an electrode for a high-output energy storage device of claim 10, wherein the lithium manganese oxide formed in the carbon material has a lithium manganese oxide-spinel structure.

13. The lithium manganese oxide-carbon nano composite for manufacturing an electrode for a high-output energy storage device of claim 10, wherein the carbon material is any one of carbon black, a carbon nano tube (CNT), a carbon nano fiber (CNF), a vapor grown carbon fiber (VGCF), graphite, and grephene.

14. The lithium manganese oxide-carbon nano composite for manufacturing an electrode for a high-output energy storage device of claim 10, wherein the lithium manganese oxide is LiMn₂O₄.

15. An apparatus for manufacturing a lithium manganese oxide-carbon nano composite, comprising:
an airtight chamber receiving a lithium ion solution and a manganese ion solution and synthesizing a lithium manganese oxide with a carbon nano composite;
a heat supply unit supplying heat to the airtight chamber;
a temperature-pressure measuring unit measuring at least one of temperature and pressure in the airtight in order to control heat supplied to the heat supply unit; and
a temperature-pressure control unit controlling at least one of temperature and pressure according to the measured temperature and pressure.

16. The apparatus for manufacturing a lithium manganese oxide-carbon nano composite of claim 15, wherein the heat supply unit is a microwave scanning apparatus.
